(19) United States
(12) Patent Application Publication
(10) Pub. No.: US 2002/0149600 A1
(43) Pub. Date: Oct. 17, 2002

(54) Method of blending digital pictures

(76) Inventors: Marinus Van Splunter, Helmond (NL); Patrick Fransiscus Paulus Meijers, Eindhoven (NL)

Correspondence Address: U.S. Philips Corporation, 580 White Plains Road, Tarrytown, NY, 10591, US

(21) Appl. No.: 10/116,553

(22) Filed: Apr. 4, 2002

(30) Foreign Application Priority Data
Apr. 9, 2001 (EP) 01201305.8

(51) Int. Cl. G09G 5/02

(52) U.S. Cl. 345/592

(57) ABSTRACT

The invention relates to a method of composing digital images. The pixel color values and opacity values of a source and a destination image (1,2) are combined in accordance with a set of blending equations. The invention proposes blending equations involving the source and destination opacity values, such that the opacity of the destination image is reduced, wherein the decrease of the opacity values of the destination image (2) is controlled by the opacity values of the source image (1). The blending method of the invention imitates aquarelle painting. In real aquarelle painting, the previously painted (destination) image can be partially dissolved by the water which is used in painting on top of the previous image. Likewise, the invention proposes a decrease of the opacity of the destination image (2) proportionally to the opacity of the source image (1), thereby reducing the opacity of the resulting image (8) in those regions (9) where the source image (1) is opaque.

The invention relates to a method of composing of digital images, wherein a source image is blended with a destination image, the source and destination images providing source and destination pixel color values and source and destination opacity values, and wherein new destination color and opacity values are computed in accordance with a set of blending equations, which blend the source and destination pixel color values and the respective opacity values.

Furthermore, the invention relates to a computer program for carrying out the method of the invention and a video graphics appliance with a programming which operates in accordance with this method.

In computer graphics, a digital image is usually represented by a rectangular array of pixels. A pixel value may include three colorant values: one for red (R), green (G) and blue (B). Instead of the RGB scheme, for example a CMYK (cyan, magenta, yellow, key) color space may be employed. Blending is a technique that combines the color values of a “source image” and a “destination image” to create new destination colors. The transparency of the source image indicates the extent to which the underlying destination image may be seen through it in the resulting image. Blending implements the transparency of the source image in combining the R, G, B color values of a “source pixel” with the R, G, B color values of a corresponding “destination pixel” previously computed and stored in the computer memory. The source pixel and the destination pixel have the same x, y screen coordinates. An opacity value αₛ is associated with the source pixel and controls how many of the destination pixel color values shall be combined with those of the destination pixel. If the source image is completely opaque, the source pixel color values overwrite the existing color values of the destination image. Otherwise, a translucent image is created, which enables a portion of the existing destination color to show through the source image. The level of transparency of a source image may range from completely transparent to opaque. In standard computer systems, αₛ has a value of between 0 and 1. If αₛ=0, the corresponding pixel is transparent; if αₛ=1, the pixel is opaque. The source and destination R, G, B color values are commonly combined separately in accordance with standard blending equations, which involve the color values and the source opacity value αₛ. Such a standard blending equation is cited in, for example, U.S. Pat. No. 5,896,136:

C_{d}′=C_{d}·(1−αₛ)+Cₛαₛ

wherein C_{d}′ is the resulting destination color value, C_{d} is the original destination color value, and Cₛ is the source color value. This equation is applied separately to each of the three R, G, B values.

It is also known in the art to assign opacity values to the pixels of the destination image. Such destination opacity values α_{d} are required if successive blendings are to be carried out. After a first blending step, the new destination image is used in this case as a source image to be combined with another (third) image in a subsequent second blending step. A typical application is a computer-generated composed digital image which is to be overlaid on top of a video stream. In principle, the association of source and destination opacity values with the respective source and destination images allows an arbitrary number of consecutive blendings. In addition to the above described computation of resulting destination color values, the blending operation consequently involves the combination of the source and destination opacity values to create new destination opacity values. Appropriate blending equations have been proposed, for example, by Porter and Duff (T. Porter and T. Duff, “Compositing Digital Images”, SIGGRAPH proceedings, 1984, page 253-259):

α_{d}′=α_{d}·(1−αₛ)+αₛ

wherein α_{d}′ is the resulting opacity of the new destination image. Blending which operates in accordance with the above equations is commonly known as “alpha blending”.

One drawback of the above alpha-blending technique is that its result is not always very intuitive and predictable. Furthermore, the applicability of the known technique is disadvantageously restricted, because alpha blending does not render it possible to modify the destination opacity in such a way that the transparency of the resulting image is larger than the transparency of the original destination image. It is a very difficult task with the known blending equations to create composed images which are to be transparent in predetermined regions.

It is consequently the primary objective of the present invention to provide an improved technique of composing digital images.

It is a further object to provide the blending of a source and a destination image with the possibility of modifying the transparency of the composed image in a simple and intuitive way.

In accordance with the present invention, a method of composing digital images of the type specified above is disclosed, wherein the aforementioned problems and drawbacks are avoided by a blending equation which blends the source and destination opacity values in such a way that the opacity of the destination image is reduced, wherein the decrease of the opacity values of the destination image is controlled by the opacity values of the source image.

According to the invention, it is possible to increase the transparency of the destination image in dependence upon the transparency of the source image. This method allows arbitrary user-controlled modifications of the final opacity in the blending operation. The basic idea is that source pixels can blend with destination pixels in such a way that the source image is not only painted on top of the destination image but instead can also at least partially dissolve the previously painted destination image, thereby making the final image more transparent than the original image. The method of the invention offers a simple and intuitive way to directly control the opacity of the destination image. This is useful, for example, when the destination image is to be overlaid on top of another image, such as a video stream. In this case, in accordance with the method of the invention, the opacity of the source image controls the amount of video which will finally be visible through the composed digital image.

The method of composing digital images according to the present invention, renders it is useful to blend the source and destination opacity values in such a way that the decrease of the opacity values of the destination image is proportional to the opacity values of the source image, thereby reducing the opacity of the resulting image in those regions where the source image is opaque. In this way, the destination image is dissolved by the source pixels which have a high opacity value. The specification of opacity values at pixel level allows “painting” of transparent regions on top of the destination image, depending on the opacity distribution in the source image. This may be understood as a digital implementation of aquarelle painting. In real aquarelle painting, the previously painted image can similarly be dissolved, depending on the amount of water which is used in the painting action.

It is advantageous to further control the decrease of opacity of the destination image by a constant factor which determines the minimum opacity of the resulting image. This enables the user to easily control the final transparency of the resulting image. By introducing the constant factor, the method of the invention becomes universally applicable, because fully transparent as well as fully opaque final images can be obtained.

In a practical implementation of the method of the invention, the blending of the source and destination opacity values is carried out in accordance with the equation

α_{d}′=α_{d}·(1−αₛ)+αₛβ

where αₛ,, α_{d} and α_{d}′ are the opacity values of the source image, the original destination image and the resulting destination image, respectively, and β<1 is a constant factor which determines the decrease of opacity of the destination image. This equation is derived from the above “alpha blending” equation by simply introducing the additional β factor, which controls the minimum value of the resulting α_{d}′. The new destination opacity assumes on the value of β in those regions of the image where the source pixels are fully opaque, i.e. αₛ=1. For certain applications, it might be practical to specify also the β factor at pixel level. In the transparent regions of the source image, a certain amount of the original destination opacity α_{d} is maintained. The above equation allows implementation of the method of the invention in a very simple way. The computational effort during the blending procedure is more or less the same as with the known alpha-blending technique. If the user chooses β=1, alpha blending is performed. The new blending equation thus ensures compatibility with the known image composition techniques.

As mentioned before, the method of the invention may be understood as an implementation of digital aquarelle painting. The amount of water which is used in the painting action is reproduced by the β factor in accordance with the above equation. A small β value corresponds to the application of much water, whereby the underlying image is partially dissolved. A larger value of β corresponds to a smaller amount of water. With β=1, the source image is painted exclusively on top of the previous image without any dissolution of the previous image. The latter way of image composition is therefore more comparable with oil painting.

A computer program adapted to carry out the method of the present invention employs a blending algorithm which reduces the opacity values assigned to the pixels of the destination image, the decrease of the opacity values being controlled by the corresponding opacity values of the source image, thereby modifying the opacity of the resulting image in those regions where the source image is opaque.

For a practical implementation of such a computer program, the blending algorithm operates in accordance with the following equation:

α_{d}′=α_{d}·(1−αₛ)+αₛβ

where αₛ, α_{d} and α_{d}′ are the opacity values of the source image, the original destination image and the resulting destination image, respectively, and β<1 is a constant factor which determines the decrease of opacity of the destination image.

Such a computer program may advantageously be implemented on any common computer hardware, which is capable of standard computer graphics tasks. The computer program may be provided on suitable data carriers as CD-ROM or diskette. Alternatively, it may also be downloaded by a user from an internet server.

It is also possible to incorporate the computer program of the present invention in dedicated graphics hardware components and video appliances such as, for example, video cards for personal computers, TV sets, video cassette recorders, DVD players, or set-top boxes. The method may be utilized, for example, for displaying composed digital images such as text elements, titles or user interfaces, on top of a video stream in a semi-transparent fashion.

The following drawings disclose preferred embodiments of the present invention. It should be understood, however, that the drawings are designed for the purpose of illustration only, not as a definition of the limits of the invention.

In the drawings

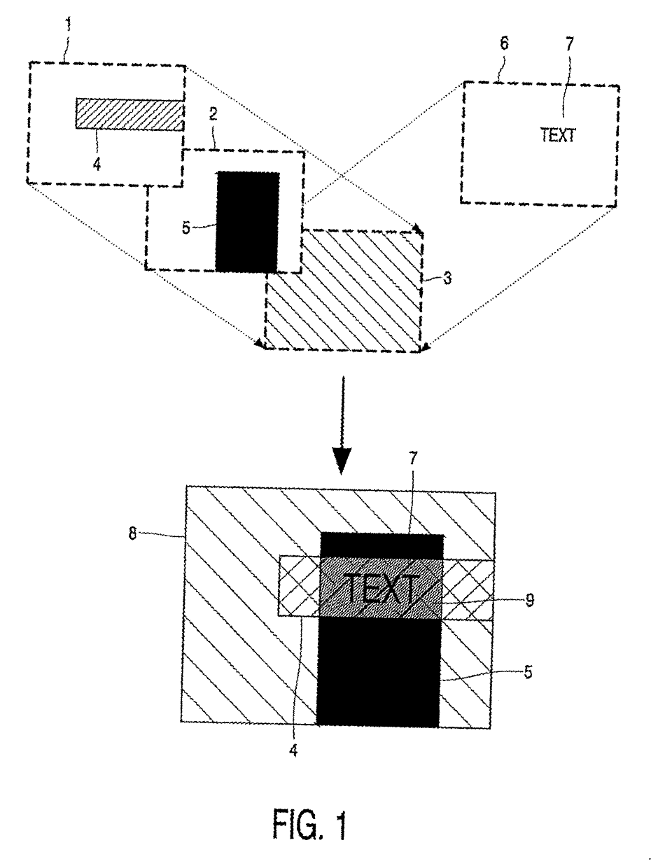

FIG. 1 shows the overlaying of a composed image on top of a video stream in accordance with the invention;

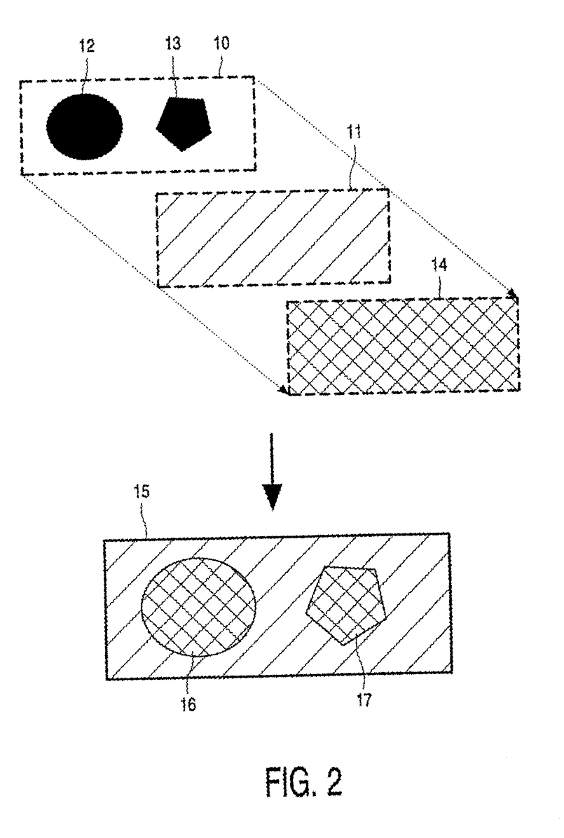

FIG. 2 shows the generation of textured graphical objects by the method of the invention;

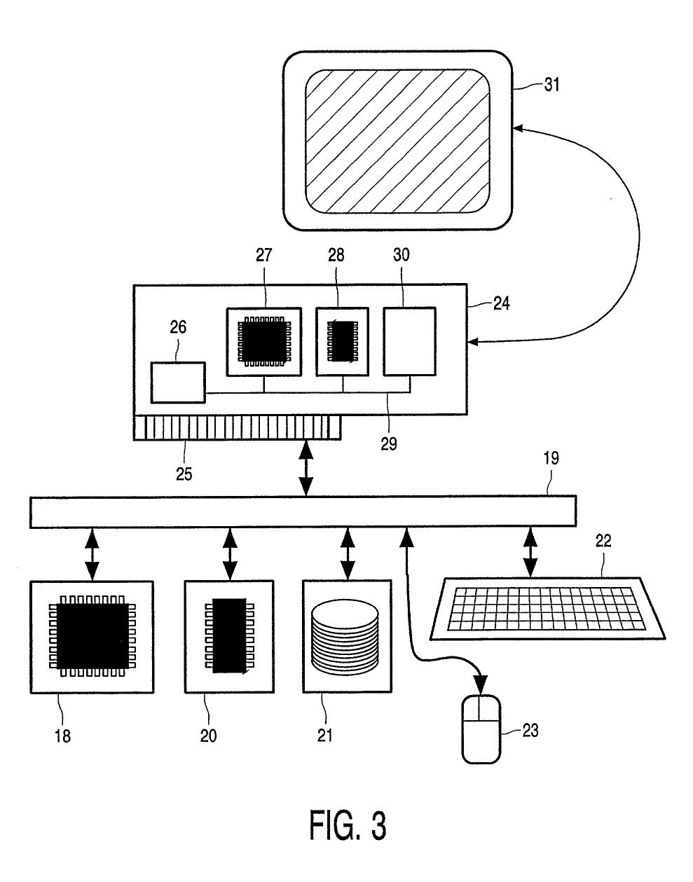

FIG. 3 shows a computer system with a video graphics card adapted to operate in accordance with the method of the present invention.

FIG. 1 shows a first digital image 1 and a second digital image 2 which are blended and overlaid on top of a video layer 3. Image 1 comprises a partially transparent colored caption box 4. The background image 2 consists of a dark colored rectangular box 5 which is fully opaque. The remaining areas of the images 1 and 2 are completely transparent. First, the source image 1 and the destination image 2 are blended in accordance with the method of the invention. The opacity of the destination image 2 is thereby decreased in the region of the caption box 4 where the source image 1 has a certain opacity. As a result, parts of the rectangular box 5 are becoming transparent, such that after the subsequent blending step of the resulting image with the video layer 3, the background video image can be partially seen through the box 5, namely in those regions of the image where the transparent caption box 4 is superimposed on top of the opaque rectangular box 5. In a final step, a digital image 6 comprising an opaque text element 7 is added. A common alpha-blending technique is employed for this purpose, such that the image 8 is finally obtained. The digital image 8 comprises all the elements of the images 1, 2, 3, and 6, which were mixed in the blending operations. The background video image 3 is not modified in those regions of the image where there are no graphical elements in the images 1, 2, and 6. The video image is mixed with the pixel colors of the caption box 4 and the dark background box 5. The background box 5 of image 2 appears partially transparent only in a rectangular region 9 which overlaps with the caption box 4 of image 1, because here the opacity was reduced during the first blending operation, which was carried out in accordance with the method of the invention.

FIG. 2 illustrates the use of the method of the present invention for generating graphical objects with a texture. First, images 10 and 11 are blended in accordance with the method of the invention. The source image 10 comprises the outlines of two fully opaque graphical objects 12 and 13. The remaining areas of image 10 are transparent. The destination image 11 consists merely of an opaque background pattern. According to the invention, the blending of source image 10 and destination image 11 is performed in such a way that the new destination image becomes fully transparent in the regions of the two graphical elements 12 and 13. As a subsequent step, the resulting image is alpha-blended with a texture image 14. In the final image 15, the texture of image 14 can be seen through the background pattern of image 11 according to the mask which is provided by the graphical elements 12 and 13 of image 10. Thus, image 15 comprises two textured graphical elements 16 and 17; the rest of the image corresponds to the opaque background pattern of image 11.

FIG. 3 shows a computer system adapted to carry out the method of the invention. It comprises a central processing element 18, which communicates with the other elements of the computer system via a system bus 19. A random access memory element 20 is attached to the bus 19. The memory 20 stores computer programs, such as operating system and application programs, which are actually executed on the computer system. During program execution, the processing element 18 reads instructions, commands and data from the memory element 20. For long-term storage of data and executable program code, a mass storage device, such as a hard disk drive 21, is connected to the bus 19. A keyboard 22 and a mouse 23 allow a user of the computer system to input information and to control the computer system interactively. Also attached to the system bus 19 is a video graphics adapter 24 with a connector element 25 to be fitted into a corresponding slot of the system bus 19. The video graphics adapter 24 comprises an interface element 26 for communication between the other elements of the graphics adapter 24 and the components of the computer system. Furthermore, a graphics accelerator element 27 and a graphics memory element 28 are attached to the graphics adapter. These are interconnected by appropriate data connections 29. The memory element 28 comprises a read-only as well as a random access memory and is correspondingly used to store the computer program of the present invention and parts of the digital images which are to be composed. The graphics accelerator 27 is a microprocessor or a microcontroller for carrying out the blending operations in accordance with the method of the present invention. The graphics adapter 24 further comprises a video signal generator 30 connected to a computer monitor, which might be a CRT or a LCD display device. It generates video signals for the two dimensional display of the resulting digital images, which are composed by the elements of the video graphics adapter 24.

Accordingly, while a few embodiments of the present invention have been shown and described, it is to be understood that many changes and modifications may be made thereunto without departing from the spirit and scope of the present invention as defined in the appended claims.

1. A method of composing of digital images, wherein a source image (1) is blended with a destination image (2), the source and destination images providing source and destination pixel color values and source and destination opacity values, and wherein new destination color and opacity values are computed in accordance with a set of blending equations, which blend the source and destination pixel color values and the respective opacity values, characterized in that the blending equation blends the source and destination opacity values in such a way that the opacity of the destination image is reduced, wherein the decrease of the opacity values of the destination image (2) is controlled by the opacity values of the source image (1).

2. A method as claimed in claim 1, characterized in that the decrease of the opacity values of the destination image (2) is proportional to the opacity values of the source image (1), thereby reducing the opacity of the resulting image (8) in those regions (9) where the source image is opaque.

3. A method as claimed in claim 1, characterized that the decrease of opacity of the destination image (2) is additionally controlled by a constant factor which determines the minimum opacity of the resulting image (8).

4. A method as claimed in claim 1, characterized in that the blending of the source and destination opacity values is carried out in accordance with the equation
α_{d}′=α_{d}·(1−αₛ)+αₛβ
where αₛ, α_{d} and α_{d} are the opacity values of the source image, the original destination image and the resulting destination image, respectively, and β<1 is a constant factor which determines the decrease of opacity of the destination image.

5. A computer program for carrying out the method as claimed in claim 1, which composes a source and a destination digital image by blending the source and destination pixel color values and the respective opacity values, characterized in that a blending algorithm is employed which reduces the opacity values assigned to the pixels of the destination image, the decrease of the opacity values being controlled by the corresponding opacity values of the source image, thereby modifying the opacity of the resulting image in those regions where the source image is opaque.

6. A computer program as claimed in claim 5, characterized in that the blending algorithm operates in accordance with the following equation:
α_{d}′=α_{d}·(1−αₛ)+αₛβ
where αₛ, α_{d} and α_{d} are the opacity values of the source image, the original destination image and the resulting destination image, respectively, and β<1 is a constant factor which determines the decrease of opacity of the destination image.

7. A video graphics appliance, such as a video graphics adapter for computer systems, a TV set, a video cassette recorder, a DVD player, or a set-top box, with a program-controlled processing element, characterized in that the graphics appliance has a programming which operates in accordance with the method as claimed in claim 1.
